(19) United States
(12) Patent Application Publication
(10) Pub. No.: US 2014/0135569 A1
(43) Pub. Date: May 15, 2014

(54) INCUBATOR WITH COATED INCUBATOR HOOD

(71) Applicant: Dräger Medical GmbH, Lubeck (DE)

(72) Inventors: Hans-Ullrich HANSMANN, Barnitz (DE); Michael RIECKE, Lubeck (DE); Henryk SCHNAARS, Lubeck (DE)

(73) Assignee: Dräger Medical GmbH, Lubeck (DE)

(21) Appl. No.: 14/075,501

(22) Filed: Nov. 8, 2013

(30) Foreign Application Priority Data
Nov. 12, 2012 (DE) 10 2012 022 185.1

(51) Int. Cl. A61G 11/00

(52) U.S. Cl. CPC A61G 11/00
USPC 600/22

(57) ABSTRACT

An incubator (12) includes an incubator hood (11) with two side walls (2, 3), a front wall (4), a rear wall (5) and preferably an upper wall (6), which have each inner and outer surfaces. One or more of the inner and/or outer surfaces of one or more of the walls (2, 3, 4, 5, 6) of the incubator hood are provided with a coating. The coating is electrically conductive and essentially optically transparent. The electrical conductivity of the coating is designed to heat the coated walls, similarly to a resistance heater, to a desired temperature by applying an electric voltage in order to prevent thereby water of condensation from forming. The coating is essentially scratch resistant.

### CROSS REFERENCE TO RELATED APPLICATIONS

This application claims the benefit of priority under 35 U.S.C. §119 of German Patent Application DE 10 2012 022 185.1 filed Nov. 12, 2012, the entire contents of which are incorporated herein by reference.

### FIELD OF THE INVENTION

The present invention pertains to an incubator hood (incubator wall configuration) for an incubator as well as to an incubator with such an incubator hood.

### BACKGROUND OF THE INVENTION

Conventional incubators usually have an incubator hood, which covers the reclining surface of the incubator and which may be provided with one or more side flaps, via which the health care staff has access to the interior space of the incubator and thus to the newborn. Further, prior-art incubators are usually equipped with heat generating means (e.g., heat radiators and/or warm air generating means) in order to thus guarantee in the interior space of the incubator (and thus for the newborn) a suitable microclimate, in which temperatures of up to 39° C. and a relative humidity of up to 99% may prevail along with a very high oxygen content in the interior space of the incubator.

Water of condensation may form on the inner surfaces of the incubator hood due to the high humidity and due to the high internal temperature within the incubator, because the ambient temperature (e.g., room temperature) of the incubator, and thus also the temperature on the inner surfaces of the incubator hood, is below the temperature in the interior space of the incubator (i.e., at below 39° C.). The inner surfaces of the transparent incubator hood may become fogged thereby, as a result of which the visibility of the newborn is reduced. Furthermore, the water condensing on the inner surfaces of the incubator hood may lead to the formation of droplets, which is not desirable, because these droplets may run down on the inner surfaces of the hood to the reclining surface and soak same.

Even though the condensation of water on the inner surfaces of the incubator hood can be prevented from occurring by improving the thermal insulation of the hood, such a thermal insulation can be achieved only by using a markedly greater material thickness or by a double-walled design of the hood. However, the hood becomes very expensive due to both measures and also very unwieldy because of the heavier weight.

Temperatures of about 39° C. in conjunction with an air humidity of up to 99% represent an optimal climate for the growth of microbes and other pathogens, which may spread especially at sites on the inner surfaces of the incubator hood that are difficult to reach and difficult to clean. In addition, the surfaces of the incubator hood is scratched in a short time due to frequent cleaning, and the grooves of these scratches form a good substrate for the growth of microbes.

### SUMMARY OF THE INVENTION

A basic object of the present invention is therefore to make available an incubator hood or an incubator provided with such a hood in order to overcome the drawbacks explained above. One object of the present invention is, in particular, to make available an incubator hood whose surfaces (especially the inner surfaces) possess properties for avoiding or reducing the above drawbacks.

According to the present invention an incubator hood (incubator wall arrangement) is provided with two side walls, with a front wall, with a rear wall and preferably with an upper wall (6), which each have inner and outer surfaces. One or more of the inner and/or outer surfaces of one or plurality of the walls of the incubator hood is/are provided with a coating. The coating is electrically conductive and essentially optically transparent. The electrical conductivity of the coating is designed to heat the coated walls by applying an electric voltage to a desired temperature in order to thereby prevent water of condensation from forming on the walls of the incubator hood. The coating is essentially scratch resistant. The present invention pertains, in particular, to an incubator hood that is provided with a coating, which is essentially optically transparent and has an electric conductivity. Furthermore, this coating is relatively scratch resistant and preferably possesses microbicidal properties. The coating may be provided on one or on a plurality of the inner and/or outer surfaces of the incubator hood.

According to the present invention, one or more of the inner and/or outer surfaces of the incubator hood is/are provided with an electrically conductive, essentially optically transparent and preferably scratch-resistant coating, which may contain microbicidal particles. This coating may be designed as a single layer, by means of which the above properties are embodied. As an alternative, two or more layers located one on top of another may be provided, i.e., for example, a first, optically transparent layer, which is electrically conductive, and a scratch-resistant second layer, which preferably possesses microbicidal properties. The first and second layers thus form a composite layer possessing different, mutually complementary properties. A first, electrically conductive layer, a second scratch-resistant layer and a third layer possessing microbicidal properties may theoretically be provided as well. However, other sequences of layers are possible as well.

The term “essentially optically transparent” shall be defined such that the coating of the incubator hood has an optical transparency of at least 50%, preferably at least 75% and especially preferably at least 90%.

The present invention will be described with reference to an incubator with an incubator hood. These incubator hoods usually have the shape of a cuboid open at the bottom with one upper wall, two side walls, a front wall as well as a rear wall. However, the incubator hood may also have the shape of a “bell-shaped butter dish” with a single arched wall. However, the present invention also comprises “open” incubators, which have only one or more side panels, which surround the reclining surface and extend vertically upwardly from the sides of the reclining surface, instead of an incubator hood (or hood without upper wall). The side panels (side walls) may be provided in these open incubators or open patient care units with the coating explained above on their inner and/or outer surfaces.

According to a first embodiment of the present invention, the electrically conductive, optically essentially transparent first layer on the inner and/or outer surfaces of the hood of the incubator is applied as a coat or vapor-deposited. A scratch-resistant second layer, which may contain microbicidal particles, is subsequently applied to this first layer. This second layer may likewise be applied as a coat or by means of a sol-gel method. This sequence of transparent electrically conductive first layer and the preferably transparent, scratch-resistant, microbicidal second layer is preferably applied to the wall surfaces of the hood that face inwardly. As an alternative or in addition, both layers may also be applied in the sequence mentioned to the wall surfaces of the hood that face outwardly. It is also possible to provide only some of the wall surfaces (i.e., walls) with the electrically conductive layer.

The first layer and the second layer may be applied as a mixture of the two layers to the hood of an incubator in another embodiment. This means that this “mixed coating” is electrically conductive, scratch resistant, essentially transparent and preferably contains microbicidal particles. The incubator hood (i.e., its walls) or the side panels of the open incubator preferably consist of glass or transparent plastics, e.g., PMMA or polycarbonate. All walls of the hood or all side panels of the incubator are preferably essentially optically transparent. However, it is also conceivable that one or more walls of the hood are semitransparent or nontransparent.

In summary, the coating of the incubator hood (or of the side panels) according to the present invention has electrical conductivity, which is designed and suitable for heating the incubator hood by sending current through it, regardless of whether the coating is a mixed coating or a composite coating comprising a plurality of layers. One or more heatable surfaces can be formed due to this electrically conductive layer or coating, similarly to the case of a resistance heater. Either all walls (inner side and/or outer side), or selected walls, of the incubator hood may be coated for this. The selection of the coated walls depends on how the walls of the incubator hood shall be heated and on which of the walls of the incubator hood shall be heated. It is likewise conceivable that only certain walls of the hood are provided with an electrically conductive coating, but also walls receive a scratch-resistant coating. It is possible as a result to limit the flow of current for heating the walls of the hood to some desired walls. This may be desirable for reasons of energy consumption and/or for reasons of a simplified manufacture of the hood. It is thus possible, for example, to provide only the side walls and the upper wall with an electrically conductive coating, as a result of which an essentially uniform flow of current is achieved from the lower edge of a side wall, via the upper wall up to the lower edge of the other side wall. Current-conducting strips, which can be connected to a power source or voltage source, are provided for this at the lower edges of the side walls. Other walls (preferably their inner surfaces) may, of course, also be provided with an electrically conductive coating in the above case for reasons of manufacture, the unheated walls or wall surfaces being electrically insulated in this case from the heated wall surfaces by suitable measures. This may be brought about, for example, by means of corresponding interruptions of the electrically conductive coating (e.g., by subsequently removing the coating at the lateral edges of the wall surfaces or by masking insulation lines that are not to be coated).

Prior-art resistance heaters for heating surfaces are formed, for example, by spraying copper on a suitable substrate. The spraying of copper does, however, have the drawback that the layers thus formed are not usually sufficiently transparent optically and therefore cannot be used for incubator hoods. Examples of transparent electrical heaters are disclosed in U.S. Pat. No. 5,285,519 A and WO 2010/107724 A1. Further examples of heaters are found in DE 10 2006 018 748 B4 and WO 08/145,750 A, the entire contents of which are incorporated herein by reference.

The coated walls or wall surfaces of the hood can be heated by means of the electrical conductivity of the coating of the incubator hood according to the present invention by a suitable flow of current being brought about through the coating. The respective coated wall surfaces or walls can be brought by this heating to a desired temperature in order to prevent but at least to reduce thereby water of condensation from forming. The electrically conductive coating is preferably applied to the inner surfaces of the walls of the hood in order to thus prevent or at least reduce the formation of water of condensation, which occurs essentially on the inner surfaces of the walls of the hood. The growth of microbes, microorganisms and other pathogens can be markedly reduced due to the prevention or reduction of the formation of water of condensation on the inner surfaces of the walls of the hood. In addition, the optical transparency of the incubator hood is not compromised by the disturbing formation of water of condensation. As was explained above, one or more or all walls of the incubator hood may be heated. This can be brought about either by a selective coating of the walls or wall surfaces or by a suitable electrical contacting (i.e., flow of current) and/or insulation of the respective heated (or unheated) walls of the hood.

The electrical conductivity is preferably brought about in the incubator hood according to the present invention by means of a layer consisting of electrically conductive carbon fibers and/or carbon nanotubes in a polymer matrix, wherein said polymer matrix may likewise be electrically conductive. These carbon fibers or carbon nanotubes have such a small diameter that the electrically conductive layer remains essentially optically transparent. As an alternative, an optically transparent, electrically conductive layer can be obtained by a corresponding application by vapor deposition of a thin metal layer on the respective surfaces.

Another possibility is to apply or introduce electrically conductive structures (e.g., wires, wire meshes or wire nettings), in which case the wire diameters are selected to be so small that the reduction of transparency can be considered to be very small. The diameter of the wires equals a few micrometers only, preferably less than 50 μm. The conductive structures may be incorporated in a polymer matrix, which may be electrically conductive.

It is decisive that the electrically conductive layer has a transparent composition, which has sufficient thermal stability and excellent optical transparency. For example, the electrically conductive composition may contain at least one conductive polymer and carbon nanotubes (CNT), wherein very small quantities of carbon nanotubes are dispersed into an electrically conductive polymer or a mixture of electrically conductive polymers. The advantage of adding carbon nanotubes is that the electrical conductivity of the layer thus formed is markedly increased. Examples of electrically conductive polymers are polyanions, polypyrroles, polyaniline, polythiophenes, polyparaphenylenes, polyparaphenylene-vinylenes, and derivatives thereof. However, no electrically conductive polymers must be used, because the use of carbon fibers or carbon nanotubes makes the layer sufficiently electrically conductive in case of a sufficient dose. It is not absolutely necessary to use carbon nanotubes. The diameter of carbon nanotubes is preferably in the range of 0.4 nm to 50 nm. Thicker carbon fibers with a diameter of up to a few μm may be used as well, because these are not perceived as disturbing by the human eye.

It proved to be sufficient in practical experiments to disperse about 0.01 wt. % of carbon nanotubes into at least one electrically conductive polymer in order to achieve, firstly, the desired electrical improvement of the electrical conductivity, and, secondly, the high optical transparency of the polymers to a great extent. The electrical conductivity can, of course, be improved even more by the addition of larger quantities of carbon nanotubes, but this leads to a reduction of transparency. However, transparency is reduced to a value of, for example, 70%, as is often desirable, for example, for tinted automobile windshields and windows. Such a preset transparency can be readily set very accurately by adding quantities of carbon nanotubes.

It likewise proved to be sufficient in practical experiments if about 0.5 wt. % of carbon nanotubes are dispersed into the polymer matrix. However, it is also possible, if necessary, to disperse more than 0.5 wt. %.

It is possible, for example, to make available electrical resistor elements with high optical transparency (>95%), which have very high temperature stability and are very well suited for use as heating elements for an incubator hood, by adding small quantities of carbon nanotubes. The electrical conductivity can be improved even further by adding larger quantities of carbon nanotubes.

The electrically conductive composition may be applied to the surfaces of the incubator hood, for example, by spray-coating, spraying, doctoring, spin-coating (rotation coating), dip-coating, painting with a brush or spraying. These layers represent a two-dimensional electrical resistance. Scratches at right angles to the flow of current in this conductive layer may lead to an unfavorable current distribution and hence to undesired temperature distribution.

The above-described electrically conductive layer is highly susceptible to scratching and must therefore be protected. This is achieved by means of an additional scratch protection layer. The scratch resistance of this layer is achieved by incorporating nanoparticles having high hardness in the plastic matrix. These nanoparticles are preferably incorporated on the surface of this plastic matrix. These particles consist mainly of carbides.

The microbicidal properties of this scratch-resistant layer can be obtained by incorporating microbicidally active chemicals in the surface of this layer. These particles may be, for example, finely dispersed silver particles or silver salt particles, antimicrobial metal oxides, immobilized organic acids or other biocides, for example, triclosan. These particles must be bound chemically such that they do not separate from the plastic matrix, or have such a high molecular weight that the vapor pressure of the species is correspondingly low. The microbicidal particles may be easily separated from the immediate surface by constant disinfection by wiping and washed out. This is prevented by a corresponding immobilization of the active particles or the problem is solved by the active species washed out from the surface being able to be replaced by diffusion from the depth of the material to the surface. Several action mechanisms are available for this. However, the active particles must be small enough to remain optically transparent in the visible wavelength range.

Examples of microbicidal surfaces and materials are disclosed in the following documents: DE 20 2005 012 016 U, DE 20 2005 014 409 U, DE 25 44 230 A1, DE 197 50 122 A1, DE 101 32 937 A1, DE 10 2005 042 372 B3, EP 1 748 353 A, US 2001/013907 A, US 2003/111075 A, US 2004/029834 A, US 2005/080157 A, US 2008/032119 A, US 2009/252699 A, US 2009/252804 A, US 2010/059053 A, US 2010/255048 A, US 2010/092530 A, WO 99/17188 A, WO 01/46900 A and WO 08/084,187 A, the entire contents of which are incorporated herein by reference.

As was explained above, the above properties can be obtained either by means of a plurality of layers applied one on top of another and arranged one above another or by means of a mixture of a plurality of species having different actions in a polymer matrix.

If the quantity of energy needed for heating the surfaces of the incubator hood shall be reduced, it is preferred not to heat all walls, as this was already described above. In addition, the quantity of energy needed can be further reduced by designing the incubator hood as a double-wall incubator hood. It was found that the quantity of energy needed can be reduced by about half by the double-wall design. In addition, the electrically conductive layer can be protected even better by the double-wall design by this layer being provided, for example, between the double walls. The inner surfaces of the inner walls can be provided with an essentially optically transparent and preferably scratch-resistant coating, which may contain microbicidal particles, in such an embodiment as well. However, if the coating is provided on the wall surfaces in the interior space between the walls of the double-wall structure, the scratch resistance and/or microbicidal properties are not absolutely necessary, because the coating in the interior space is located between the walls and is not therefore accessible from the outside. Reference is made in this connection to U.S. Pat. No. 5,285,519.

The present invention will be described now on the basis of an exemplary embodiment with reference to the figures, on the basis of which an exemplary embodiment of the incubator hood according to the present invention will be explained. However, the present invention is not limited to this exemplary embodiment. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective view of an exemplary incubator;

FIG. 2 is a perspective view of the incubator from FIG. 1 with an exemplary current distribution through the electrically conductive layer;

FIG. 3a is a cross-sectional view of a section of an incubator hood coated with two layers;

FIG. 3b is a cross-sectional view of a section of an incubator hood coated with a mixed layer;

FIG. 4a is a perspective view of the incubator hood of the incubator from FIG. 2 with an alternative current distribution;

FIG. 4b is a view of the front wall and the rear wall of the incubator hood from FIG. 4a, in which the current feed is shown in detail; and

FIG. 5 is a schematic view of a control unit and associated power supply connected to current conducting strips.

### DESCRIPTION OF THE PREFERRED EMBODIMENTS

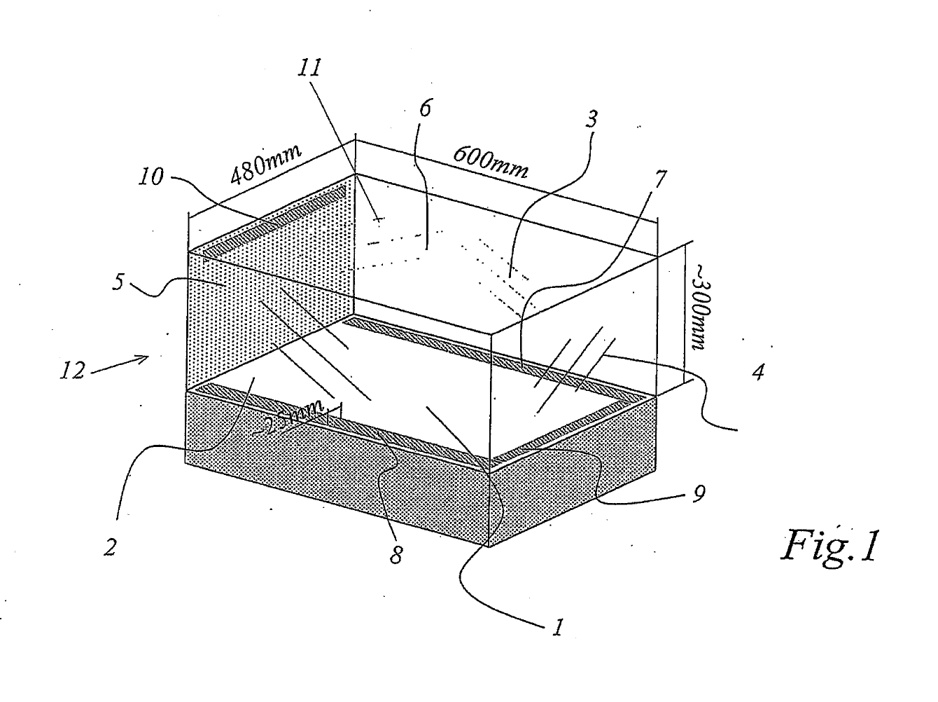

Referring to the drawings in particular, the incubator 12 according to the present invention from FIG. 1 has, for example, on the sides of a reclining surface 1, outlet ducts (7, 8, 9), which extend in parallel in the longitudinal direction and at right angles to the longitudinal direction in the foot area, from which air conditioned in terms of temperature and humidity flows into the interior space of the incubator, which is defined by the walls of an incubator hood 11. Ducts 7, 8, 9 have an exemplary width of 25 mm. A temperature of up to 39° C. and a humidity of up to 99% can be reached in the interior space of the incubator due to the conditioned air, which has a high oxygen content. The incubator hood 11 has two side walls 2, 3 on the long side, a side wall 4 on the foot side, an upper wall 6 extending essentially in parallel to the reclining surface 1, and a side wall 5 on the head side. The exemplary incubator 12 has a width of about 480 mm and a length of about 600 mm. The incubator hood 11 has a height of about 300 mm. The size data given are, however, of only an exemplary nature. Thus, the hood may also have a length of about 820 mm, a width of about 440 mm and a height of about 450 mm. The head-side side wall has in the upper area an air exhaust unit 10, which has a passage area of, for example, about 30×300 mm. The air, which is drawn off by the exhaust unit 10 with a fan, not shown, and which is mixed with the ambient air, is circulated and is returned into the incubator via the outlet ducts 7, 8, 9. The output of air circulation thus changes depending on the setting of the velocity of the air and depending on the configuration of the incubator 12. The outlet ducts may have mechanical and electric motor-operated setting means for setting an air velocity distribution. The electric motor-operating setting means are preferably actuated via a central control and analysis unit. As an alternative, the corresponding settings may also be performed manually by a human operator or medical health care staff at the central analysis and control unit 50.

The inner surfaces of the walls 2, 3, 4 and 6 are provided with the above-described coating in the exemplary embodiments shown in FIG. 1. As an alternative, or in addition, the outer surfaces of the walls of the hood may also be provided with the coating. It is possible, furthermore, to coat, for example, the inner surfaces of all walls 2, 3, 4, 5 and 6, or only the surfaces 2, 6 and 3, doing so on the outer surfaces and/or on the inner surfaces.

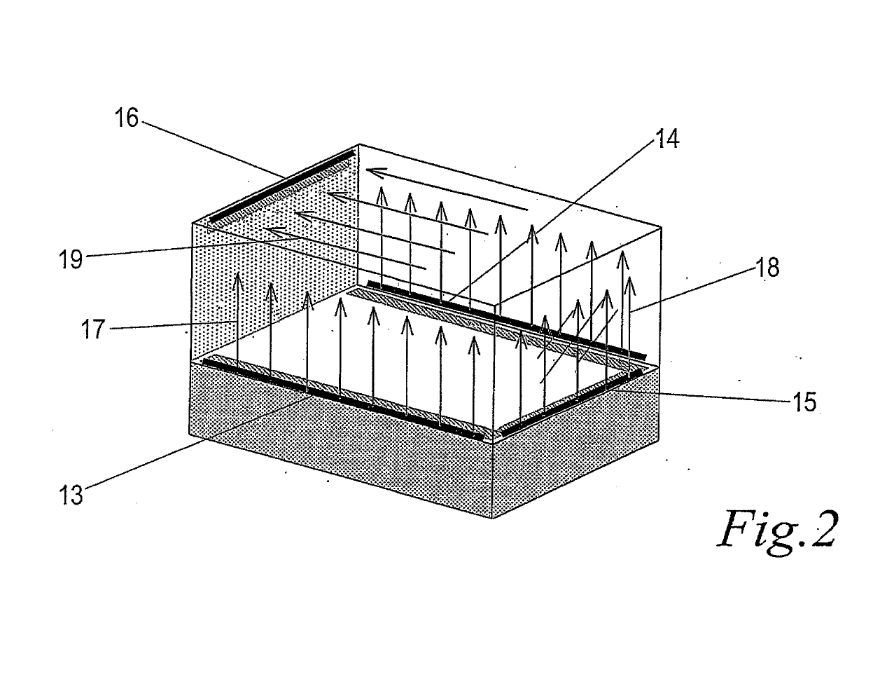

FIG. 2 shows incubator 12 with the incubator hood 11 from FIG. 1. As was explained in reference to FIG. 1, the two side walls 2 and 3, the foot-side wall 4 and the upper wall 6 are preferably provided in the exemplary embodiment on the inner side with an electrically conductive coating, which is essentially optically transparent and scratch resistant, and which preferably possesses microbicidal properties. As can be seen in FIG. 2, electrically conductive current-conducting strips 13, 14, which are provided on the same side as the coating and are electrically coupled with the electrically conductive coating, are applied at the lower edges of both side walls. Furthermore, another current-conducting strip 15, which is likewise coupled with the electrically conductive coating, is provided at the lower edge of the foot-side wall. Finally, a current-conducting strip 16, which is coupled with the coating of the upper wall 6, is provided at the head-side edge of the upper wall.

The current-conducting strips 13, 14, 15 are coupled with a first pole 52 of a power supply unit 54 via suitable plug or contact connections 56, and current-conducting strip 16 is coupled with a second pole 58 of the power supply unit 54 via an electrical connection and a suitable plug or contact connection 60. If a suitable voltage is applied between the current-conducting strips 13, 14, 15 and the current-conducting strip 16, a current will flow through the conductive coating on the inner surfaces (or alternatively on the outer surfaces) of the coated walls, as this is represented by the arrows 17, 18, 19. The current distribution on the coated walls can be controlled by varying the thickness of the conductive layer or by varying the density of conductive particles in the conductive layer in order to guarantee the most uniform current distribution possible.

As was explained above, the conductive coating acts like a resistance heater. If a current flows through the conductive layer by a voltage being applied to the corresponding current-conducting strips, a relatively uniform heating of the coated walls of the incubator hood is achieved in this manner, providing that a relatively uniform current density is present through the conductive layer. The temperature is selected in this case, by suitably setting the level of the voltage applied to the current-conducting strips, to be such that no water of condensation will form on the coated walls. One or more temperature sensors may be provided on the walls, and the level of the voltage applied can be controlled by the control unit 50 on the basis of the measured temperature.

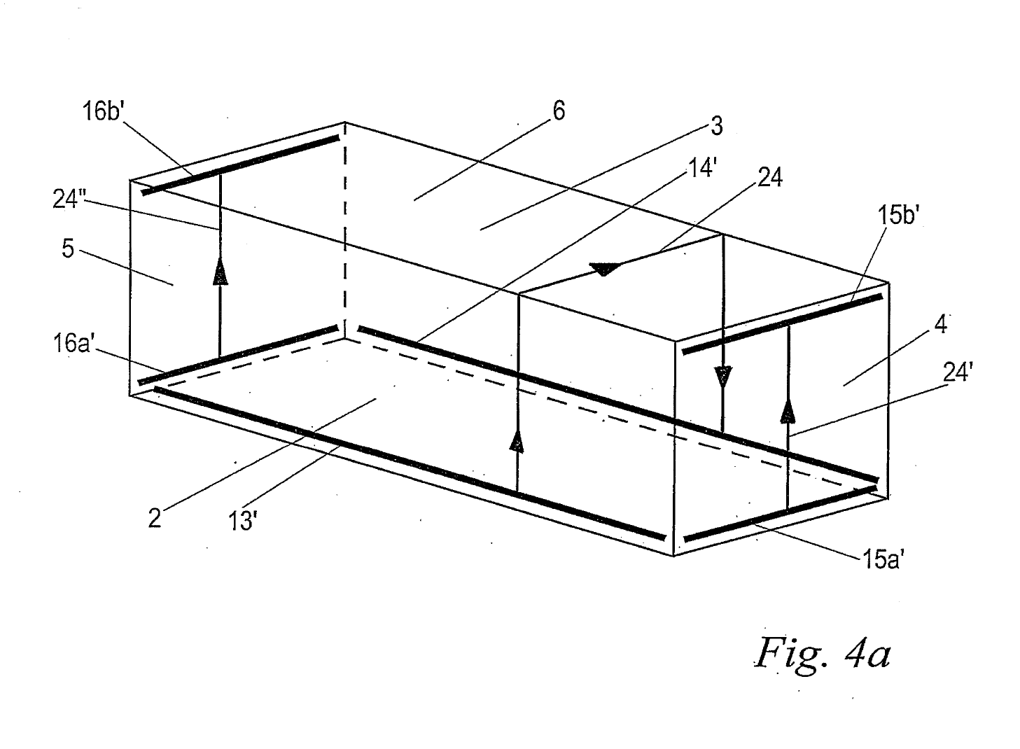

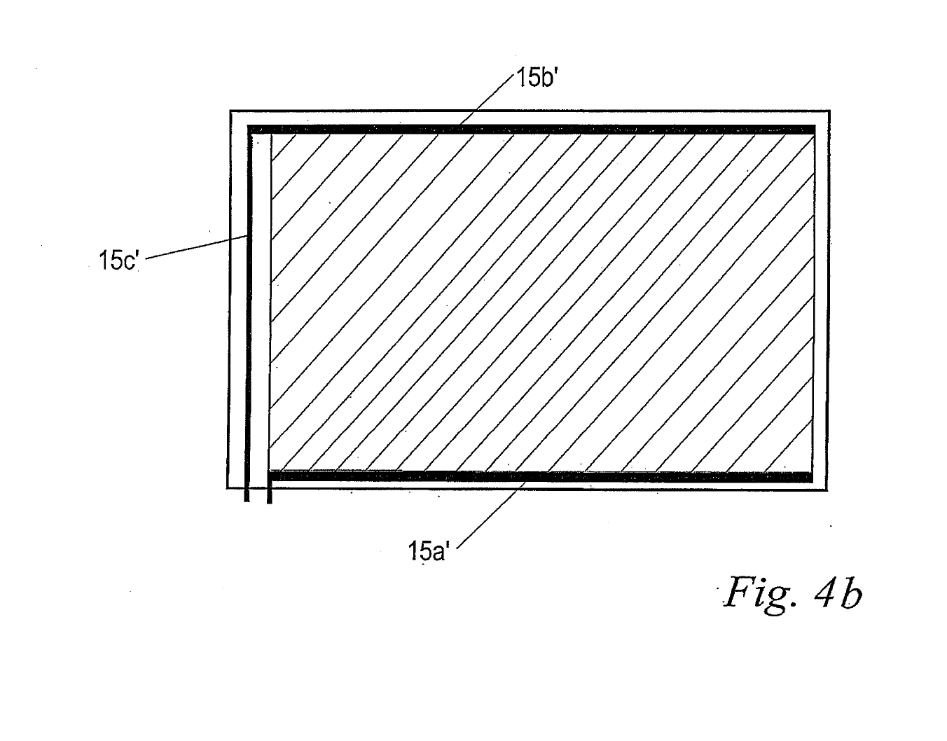

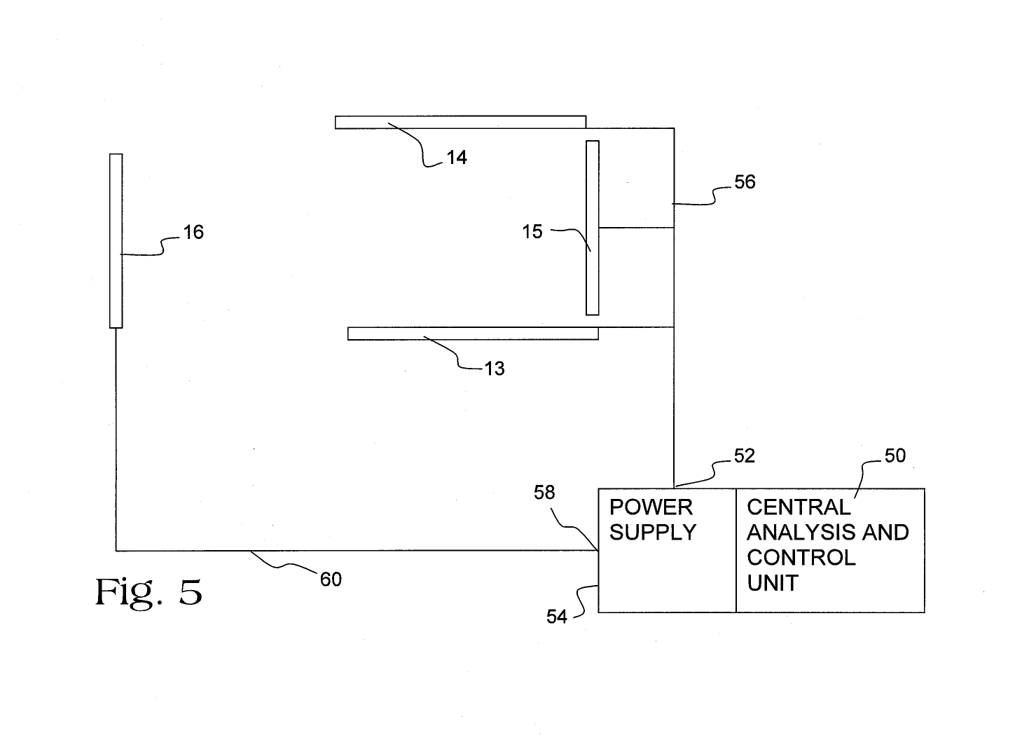

Only the side walls 2, 3 may be provided with a current-conducting strip 13, 14 in a simplified embodiment. It would be sufficient in this case to coat only the side walls 2, 3 and the upper wall 6 of the incubator hood with an essentially optically transparent and scratch-resistant layer preferably processing microbicidal properties. In this case, the current only flows through the side walls and through the upper wall. Based on this simplification, the coating of the side walls may be homogeneous, as a result of which the application of the electrically conductive layer is simplified. However, the formation of water of condensation would only, in this case, be prevented on the two coated side walls 2, 3 and on the upper wall 6. As a result, the transparency of these walls is essentially preserved. Even though the head-side and foot-side side walls 4, 5 may be fogged by water of condensation in this embodiment, this could, however, be acceptable because the clear view of the newborn would be preserved. As an alternative, the walls 4 and/or 5 can be heated, as was described in reference to FIGS. 4a and 4b, by respective separate current flows, which will be described later.

It is likewise conceivable that all walls of the incubator hood are coated, but current-conducting strips 13, 14 are provided at the lower edges of the side walls 2, 3 only. All walls have antibacterial properties in this manner, but only the walls 2, 3, 6 are heated in order to prevent water of condensation from forming on these walls. Either the walls 4 and 5 are not coated with electrically conductive material in this case, or the coating is interrupted at its edges. Such an interruption can be brought about by subsequently slightly slitting the surface or by covering (masking) during coating.

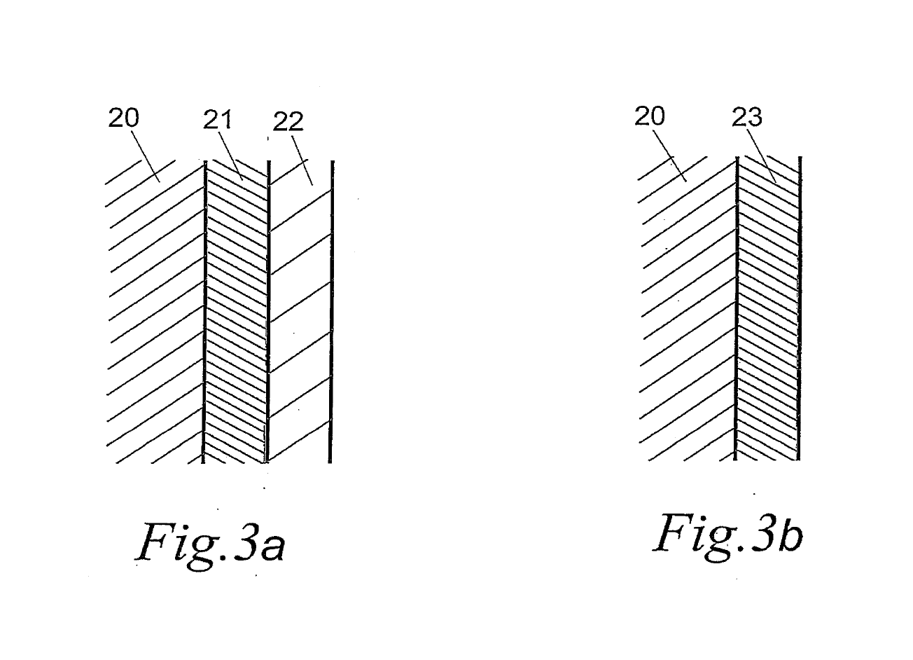

FIG. 3a shows a cross-sectional view of an area 20 of a wall of the incubator hood 11, to which a first transparent, electrically conductive layer 21 and a second, scratch-resistant, preferably microbicidal layer 22 is applied. FIG. 3b shows a cross-sectional view of an area 20 of a wall of the incubator hood 11, to which a mixed layer 23, which is transparent, electrically conductive and scratch resistant as well as preferably possesses microbicidal properties, is applied.

An electrical current-conducting strip 13′ is applied in another exemplary embodiment (see FIG. 4a) in the lower area (i.e., essentially along the lower edge) of the side wall 2, and a current-conducting strip 14′ is applied in the lower area (i.e., essentially along the lower edge) of the opposite side wall 3. These current-conducting strips (just as the corresponding conductive coating) are preferably applied on the inner surfaces of these walls. A voltage, which causes an electric current to flow, as is represented as an example by arrow 24, over the coated surfaces of the walls 2, 6 and 3, is applied between these two current-conducting strips 13′ and 14′. It is apparent that the current flows uniformly in the direction of the arrow from current-conducting strip 13′ over the coatings on the walls 2, 6 and 3 to the current-conducting strip 14′. As a result, walls 2, 6 and 3 are heated essentially uniformly. It is apparent that each of the current-conducting strips 13′, 14′ is connected to a power source via corresponding electric connections.

Current can be applied in this case to the walls 4 and 5 individually. A current-conducting strip 15a′ is provided at the lower edge and a current-conducting strip 15b′ is provided at the upper edge to apply current to the head-side side wall 4. The lower current-conducting strip 15a′ is electrically insulated from the current-conducting strip 13′ and 14′. Furthermore, the coating of wall 4 is electrically insulated from the coating of the walls 2, 6, 3. Both current-conducting strips 15a′, 15b′ are connected to the power source via corresponding electric connections. As a result, an electric current flows through the coating of wall 4 between the current-conducting strips 15a′ and 15b′, as is indicated by arrow 24′. Current can also be applied in a similar manner to wall 5, for which purpose a lower current-conducting strip 16a′ and an upper current-conducting strip 16b′, which are electrically insulated from the coatings and the current-conducting strips of the walls 2, 6, 3, are provided at wall 5. The current-conducting strips 16a′ and 16b′ are likewise connected to the power source via electric connections, as a result of which an electric current flows through the coating of wall 5 in the direction of arrow 24″ in order to heat this wall 5. The current-conducting strips 13′, 14′ and 15a′ and 16a′, 16b′ can be preferably controlled by the control unit separately. It is possible that some or all walls of the hood are provided with temperature sensors, which are connected to the control unit in order to control the currents between the respective current-conducting strips.

As can be seen in FIG. 4b, the foot-side wall 4 is provided with a current-conducting strip 15a′ at the bottom (i.e., essentially along the lower edge) and with a current-conducting strip 15b′ at the top (i.e., essentially along the upper edge), and a voltage is applied between the current-conducting strips 15a′ and 15b′, which causes an electric current to flow over the coated surface (represented by shading) of wall 4. Current-conducting strip 15b′ is extended downwardly via an electric line 15c′. This line 15c′ must be electrically insulated against the current-carrying surface of wall 4 (i.e., the coating) and against the current-conducting strip 15a′. Furthermore, a contact tab is provided at the current-conducting strip 15a′, so that both current-conducting strips can be connected to the power source. The solution described for wall 4 can also be applied to wall 5, for which purpose current-conducting strips 16a′ and 16b′ similar to those used for wall 4 are provided at the upper edge of wall 5. It is apparent that current-conducting strips are also provided at the vertical edges of the side walls 2, 3 and/or of the front wall 4 and/or of the rear wall 5. It is possible, furthermore, that current-conducting strips are provided at opposite edges of the upper wall. It is important that the current-conducting strips be provided such that a suitable application of current, and hence heating, of the coated walls is achieved.

It shall be noted that the current-conducting strips and the other wiring can be applied according to the thin-film technology.

It is advantageous from a thermodynamic point of view as well as based on the load on the conductive layer in terms of scratch resistance to apply the layer to the inner surfaces of the walls of the incubator.

An alternative solution may be, for example, to provide the outer surfaces of the walls 2, 6 and 3 with an electrically conductive coating and to provide the inner surfaces of the walls 4, 6 and 5 likewise with an electrically conductive coating. In addition, these coatings may, of course, also possess the scratch-resistant properties. Current-conducting strips are provided in this case at the lower edges of the walls 2 and 3, so that an electric current flows between these contact strips over the walls 2, 6 and 3 (doing so on the outer surfaces of said walls). In addition, additional current-conducting strips are provided at the lower edges of the walls 4 and 5, so that an electric current flows between these additional current-conducting strips over the walls 4, 6 and 5 (doing so on the inner surfaces of said walls). The coatings described may, of course, also be provided in the reversed manner.

While specific embodiments of the invention have been shown and described in detail to illustrate the application of the principles of the invention, it will be understood that the invention may be embodied otherwise without departing from such principles.

### APPENDIX

List of Reference Numbers

| | |
|---|---|
| 1 | Reclining surface |
| 2 | Side wall |
| 3 | Side wall |
| 4 | Foot-side side wall |
| 5 | Head-side side wall |
| 6 | Upper wall |
| 7 | Duct |
| 8 | Duct |
| 9 | Duct |
| 10 | Exhaust unit |
| 11 | Incubator hood |
| 12 | Incubator |
| 13 | Current-conducting strip |
| 14 | Current-conducting strip |
| 15 | Current-conducting strip |
| 16 | Current-conducting strip |
| 17 | Current flow |
| 18 | Current flow |
| 19 | Current flow |
| 20 | Wall of incubator hood |
| 21 | First layer |
| 22 | Second layer |
| 23 | Mixed layer |
| 24 | Arrow |
| 50 | Central analysis and control unit |
| 52 | First pole |
| 54 | Power supply unit |
| 56 | Contact connections |
| 58 | Second pole |
| 60 | Contact connections |

What is claimed is:

1. An incubator hood comprising:
a first side wall;
a second side wall;
a front wall;
a rear wall, the first side wall, the second side wall, the front wall and the rear wall each have an inner surface and an outer surface; and
a coating on at least one inner or outer surface, wherein:
the coating is electrically conductive and essentially optically transparent;
the electrical conductivity of the coating forms a heater to heat the coated wall upon application of an electric voltage to a desired temperature in order to thereby prevent water of condensation from forming on the walls of the incubator hood; and
the coating is essentially scratch resistant.

2. An incubator hood in accordance with claim 1, wherein the coating contains microbicidal properties.

3. An incubator hood in accordance with claim 1, wherein the coating is formed by a single layer or by two or more layers located one on top of another.

4. An incubator hood in accordance with claim 1, wherein the coating comprises:
a first, electrically conductive layer; and
a second, scratch-resistant layer.

5. An incubator hood in accordance with claim 1, wherein the coating comprises:
a first, electrically conductive layer;
a second, scratch-resistant layer applied to this first layer, the second layer containing microbicidal particles, wherein the second layer is applied as a coat or by means of a sol-gel method.

6. An incubator hood in accordance with claim 1, wherein the walls of the incubator hood comprise at least one of glass, and a transparent plastic, the transparent plastic comprising at least one of PMMA and polycarbonate, wherein the walls are essentially optically transparent or semi-transparent.

7. An incubator hood in accordance with claim 1, wherein the electric conductive coating comprises a layer of carbon fibers in a polymer matrix, wherein the carbon fibers have a diameter that is sufficiently small such that the electrically conductive layer is essentially optically transparent.

8. An incubator hood in accordance with claim 1, wherein electric conductive coating comprises a vapor deposed thin metal layer.

9. An incubator hood in accordance with claim 1, wherein the electrically conductive coating comprises at least one of an electrically conductive polymer and electrically conductive carbon nanotubes (CNT), wherein the carbon nanotubes are dispersed in small quantities into the electrically conductive polymer or into a mixture of electrically conductive polymers including at least one of polyanions, polypyrroles, polyaniline, polythiophenes, polyparaphenylenes, polyparaphenylene-vinylenes and derivatives thereof.

10. An incubator hood in accordance with claim 1, wherein the electrically conductive coating comprises at least one polymer and electrically conductive carbon nanotubes, wherein the carbon nanotubes are dispersed in small quantities into the polymer or into a mixture of polymers including at least one of polyanions, polypyrroles, polyaniline, polythiophenes, polyparaphenylenes, polyparaphenylene-vinylenes and derivatives thereof.

11. An incubator hood in accordance with claim 1, wherein the electrically conductive coating comprises at least one electrically conductive polymer, and electrically conductive carbon fibers, wherein the carbon fibers are dispersed in small quantities into the electrically conductive polymer or into a mixture of electrically conductive polymers including at least one of polyanions, polypyrroles, polyaniline, polythiophenes, polyparaphenylenes, polyparaphenylene-vinylenes and derivatives thereof.

12. An incubator hood in accordance with claim 1, wherein the electrically conductive coating contains at least one polymer and electrically conductive carbon fibers, wherein the carbon fibers are dispersed in small quantities into a polymer or into a mixture of polymers, for example, polyanions, polypyrroles, polyaniline, polythiophenes, polyparaphenylenes, polyparaphenylene-vinylenes and derivatives thereof.

13. An incubator hood in accordance with claim 1, wherein the scratch resistance of the coating is achieved by incorporating nanoparticles having high hardness or carbide particles into a plastic matrix, wherein the nanoparticles are incorporated on a surface of the plastic matrix.

14. An incubator hood in accordance with claim 1, wherein the coating comprises microbicidally active chemicals to provide the coating with microbicidal properties, the chemicals comprising at least one of finely dispersed silver particles, silver oxide particles, antimicrobial metal oxides, immobilized inorganic acids, immobilized organic acids, biocides and triclosan, the microbicidally active chemicals being incorporated in the surface of the coating.

15. An incubator hood in accordance with claim 1, further comprising electrically conductive current-conducting strips, which are electrically coupled with the electrically conductive coating, the electrically conductive current-conducting strips being applied at opposite edges of one or more of the coated walls, so that an electric current can flow between the current-conducting strips and through the electrically conductive coating.

16. An incubator hood in accordance with claim 15, wherein electrically conductive current-conducting strips are applied at the lower edges of the two side walls, whereby an electric current flows between the current-conducting strips and through the electrically conductive coating of the side walls.

17. An incubator hood in accordance with claim 1, wherein:
each of the front wall, the rear wall and the first and second side walls include the electrically conductive and essentially optically transparent coating; and
a current-conducting strip is coupled with the electrically conductive coating of the respective walls and is provided at the lower edge and at the upper edge of at least one of the front wall, rear wall, first side wall and second side wall.

18. An incubator hood in accordance with claim 1, wherein a current-conducting strip coupled with the electrically conductive coating is provided at opposite lateral edges of the coated wall.

19. An incubator hood in accordance with claim 15, further comprising a power supply and plug or contact connections wherein the current-conducting strips are coupled with the power supply via the plug or contact connections.

20. An incubator hood in accordance with claim 19, wherein the power supply includes a control to control a voltage applied to the respective current-conducting strips in order to achieve heating of the corresponding coated wall, wherein the temperature can be controlled by setting the voltage applied to the current-conducting strips in a suitable manner.

21. An incubator hood in accordance with claim 15, wherein the current-conducting strips are applied according to a thin-film technology.

22. An incubator comprising;
a patient reclining surface; and
an incubator hood comprising:
a first side wall;
a second side wall;
a front wall;
a rear wall, the first side wall, the second side wall, the front wall and the rear wall each have an inner surface and an outer surface; and
a coating on at least one inner or outer surface, wherein the coating is electrically conductive and essentially optically transparent, the electrical conductivity of the coating forms a heater to heat the coated wall upon application of an electric voltage to a desired temperature in order to thereby prevent water of condensation from forming on the walls of the incubator hood and the coating is essentially scratch resistant.
